(19) United States
(12) Patent Application Publication
(10) Pub. No.: US 2005/0240664 A1
(43) Pub. Date: Oct. 27, 2005

(54) System and method for configuring and managing a network device

(75) Inventors: Yi-Chien Chen, Tu-Cheng (TW); Jain-Chung Wang, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/044,778

(22) Filed: Jan. 27, 2005

(30) Foreign Application Priority Data
Feb. 13, 2004 (CN) 200410015373.2

(51) Int. Cl. G06F 15/177

(52) U.S. Cl. 709/220

(57) ABSTRACT

A system for configuring and managing a network device includes a graphical user interface (GUI) (110), a network server (120), and a core-layer module (130). The GUI receives configuring and managing demands, and for displaying information on the network device. The network server is connected to the GUI, which is used for receiving the demands from the GUI. The network server includes a network engine (121) for converting various demands to different objects, a Hypertext Markup Language (HTML) routine module (122) for generating applications based on the objects and for filling the routine templates with configuration data to generate routines, and a get/set module (123) for driving the core-layer module according to the applications to obtain the configuration data on the network device and for returning the configuration data to the HTML routine module. A related method for configuring and managing the network device is also provided.

### BACKGROUND OF THE INVENTION

1. Field of the Invention

The present invention relates to network management systems and methods, and particularly to systems and methods for configuring and managing network devices.

2. Background of the Invention

Generally, the configuration and management of a network device is performed by an administrator in a command line interface (CLI) mode. The CLI is a DOS-based user interface for the administrator to manage the network device by use of text commands.

Cisco Internet Operating System (IOS) CLI is a familiar user interface used for configuring, monitoring, and maintaining a network device. The Cisco IOS CLI includes various operating modes, such as a user EXEC mode, a privileged EXEC mode, a Virtual Local Area Network (VLAN) database mode, a global configuration mode, an interface configuration mode, and a line configuration mode. The various operating modes can be problematic for the administrator, because the operating modes have respective commands. Mastering these commands can be laborious and burdensome for the administrator. In addition, the inputting of commands letter by letter can be time-consuming.

Therefore, a system and method that allow the administrator to configure and manage the network device by using a single, familiar interface are desired.

### SUMMARY OF THE INVENTION

A primary objective of the present invention is to provide a system for configuring and managing a network device by using a graphical user interface (GUI).

A second objective of the present invention is to provide a method for configuring and managing a network device by using a GUI.

In order to accomplish the above-mentioned first objective, a preferred network management system for configuring and managing a network device includes a graphical user interface (GUI), a network server. The GUI receives configuring and managing demands, and for displaying information on the network device. The network server is connected to the GUI, which is used for receiving the demands from the GUI. The network server includes a network engine for converting various demands to different objects, a Hypertext Markup Language (HTML) routine module for generating applications based on the objects and for filling the routine templates with configuration data to generate routines, and a get/set module for driving a core-layer module according to the applications to obtain the configuration data on the network device and for returning the configuration data to the HTML routine module.

In order to accomplish the above-mentioned second objective, a preferred network management system for configuring and managing the network device comprises the steps of: (i) receiving demands and converting the demands to objects; (ii) retrieving getting routine templates and generating applications based on the objects; (iii) driving a core-layer module according to the applications to obtain configuration data on the network device; (iv) filling the getting routine templates with configuration data to generate getting routines; and (v) converting the getting routines to human-readable network getting pages to replying the getting pages for displaying configuration information to the GUI.

Other objects, advantages and novel features of the present invention will become more apparent from the following detailed description when taken in conjunction with the accompanying drawings, in which:

### BRIEF DESCRIPTION OF THE DRAWINGS

FIG. 1 is a block diagram of a network management system for configuring and managing a network device in accordance with the preferred embodiment of the present invention;

FIG. 2A schematically illustrates an exemplary a graphical user interface (GUI) in accordance with the preferred embodiment of the present invention;

FIG. 2B schematically illustrates a command tree displayed on the command display area of the GUI, in accordance with the preferred embodiment of the present invention;

FIG. 3A schematically illustrates a getting page displayed on the configuration display area of the GUI, in accordance with the preferred embodiment of the present invention;

FIG. 3B schematically illustrates a entry table displayed on the getting page of FIG. 3A in accordance with the preferred embodiment of the present invention;

FIG. 4A schematically illustrates a setting page displayed on the configuration display area of the GUI, in accordance with the preferred embodiment of the present invention;

FIG. 4B schematically illustrates a parameter table displayed on the setting page of FIG. 4A in accordance with the preferred embodiment of the present invention;

FIG. 5A is a flow chart of a preferred network management method when the GUI receives a request for obtaining configuration information, in accordance with the present invention; and

FIG. 5B is a flow chart of a preferred network management method when the GUI receives a request for resetting configuration information on the network device, in accordance with the present invention.

### DETAILED DESCRIPTION OF THE INVENTION

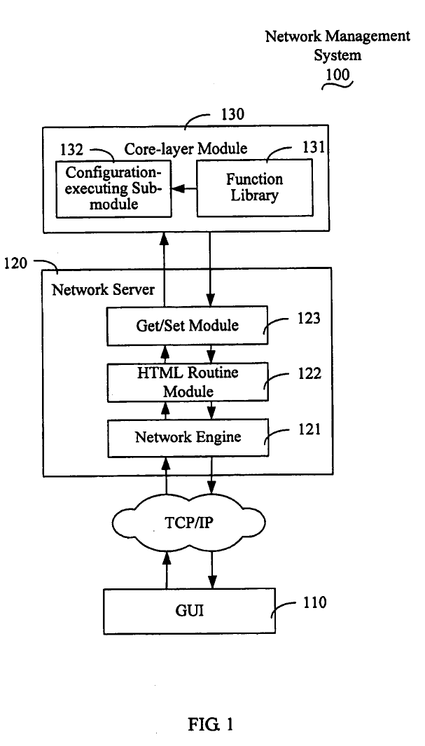

FIG. 1 is a block diagram of a network management system 100 for configuring and managing a network device in accordance with the preferred embodiment of the present invention. The network management system 100 comprises a graphical user interface (GUI) 110, a network server 120, and a core-layer module 130. The network server 120 comprises a network engine 121, an HTML routine module 122, and a get/set module 123. The core-layer module 130 comprises a function library 131 and a configuration-executing sub-module 132. The GUI 110 communicates with the network server 120 over a Transmission Control Protocol/Internet protocol (TCP/IP). The core-layer module 130 is communicationally connected to the network server 120.

The GUI 110 is used for sending a URL-encoded (Uniform Resource Locator-encoded) instruction to the network server 120 to manage configuration information on the network device. The URL-encoded instruction's URL identifies the location of a Hypertext Markup Language (HTML) routine template in the network server 120. In the embodiment of the present invention described herein, the HTML routine template is a getting template or a setting template that is stored in the network server 120.

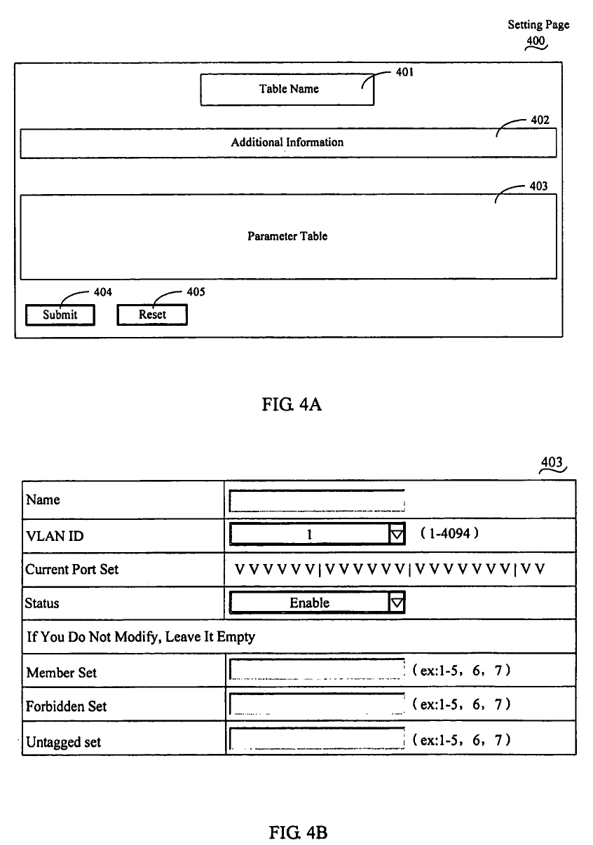

The network engine 121 is used for establishing a connection between the network server 120 and the GUI 110. The network engine 121 dynamically receives the URL-encoded instruction from the GUI 110, and converts the URL-encoded instruction to an HTML object to drive the HTML routine module 122. In the embodiment of the present invention described herein, the HTML object is a getting object for obtaining the configuration information on the network device, a search object for retrieving a setting page 400 (see FIG. 4A), or a setting object for modifying the configuration information on the network device.

If the GUI 110 receives the URL-encoded instruction for displaying the current configuration information on the network device, the network engine 121 converts the URL-encoded instruction to the getting object to drive the HTML routine module 122.

Then, the HTML routine module 122 retrieves the getting template and generates a getting application to invoke the get/set module 123 based on the getting object.

The getting application invokes a getting function of the get/set module 123 to invoke the configuration-executing sub-module 132 in the core-layer module 130.

The core-layer module 130 is used for establishing a communicational connection between the network server 120 and the network device (not shown). The function library 131 is used for storing various functions that can be invoked by the configuration-executing sub-module 132. When called by the getting function of the get/set module 123, the configuration-executing sub-module 132 invokes corresponding functions stored in the function library 131 to obtain configuration data on the network device.

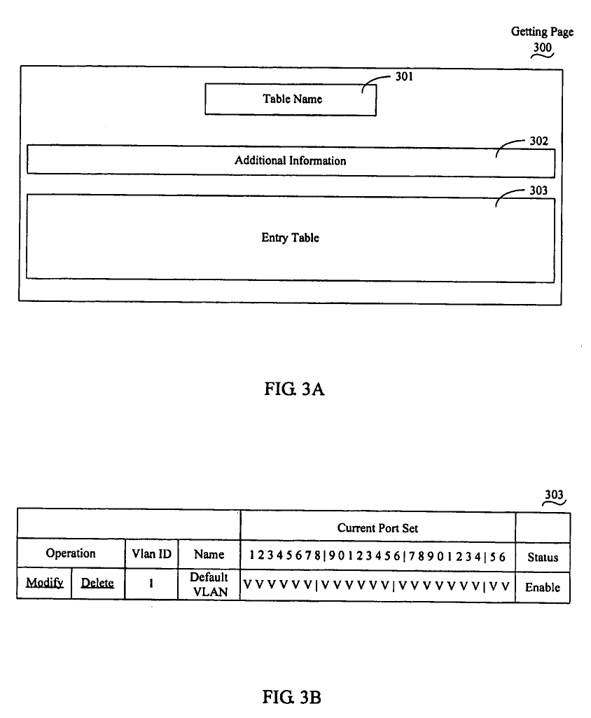

The get/set module 123 receives the configuration data on the network device, and returns the configuration data to the HTML routine module 122. The HTML routine module 122 generates a getting HTML routine based on the configuration data and the getting template. Then, the HTML routine module 122 transmits the getting HTML routine to the network engine 121. The network engine 121 converts the getting HTML routine to a getting page 300 (see FIG. 3A), and transmits the getting page 300 to the GUI 110.

If the GUI 110 sends the URL-encoded instruction to the network server 120 for obtaining the setting page 400, the network engine 121 converts the URL-encoded instruction to a search object to drive the HTML routine module 122. The HTML routine module 122 retrieves the setting template in the network server 120 based on the search object. The network engine 121 converts the setting template to the setting page 400, and transmits the setting page 400 to the GUI 110.

When the GUI 110 sends the URL-encoded instruction for modifying the current configuration information on the network device to the network server 120, the network engine 121 converts the URL-encoded instruction to a setting object to drive the HTML routine module 122.

Then, the HTML routine module 122 generates a set application based on the setting object. The set application invokes a setting function of the get/set module 123 to drive the configuration-executing sub-module 132 in the core-layer module 130.

When driven by the setting function of the get/set module 123, the configuration-executing sub-module 132 invokes corresponding functions stored in the function library 131 to update the configuration data on the network device based on the set application.

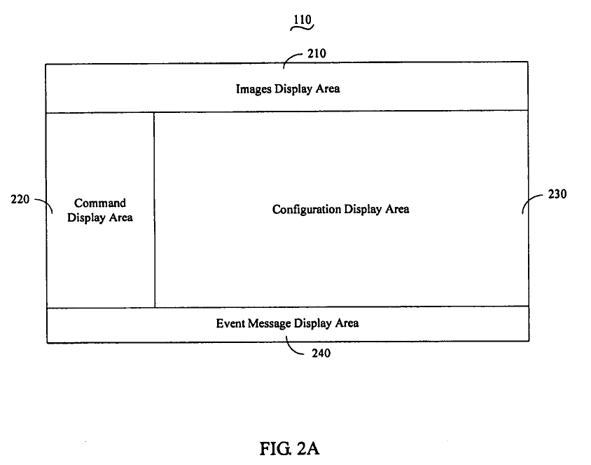

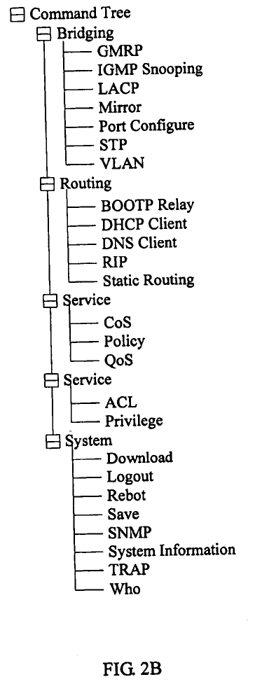

FIG. 2A schematically illustrates an exemplary GUI 110 in accordance with the preferred embodiment of the present invention. The GUI 110 comprises an images display area 210, a command display area 220, a configuration display area 230, and an event message display area 240. A front panel image is displayed on the images display area 210, for showing port statuses of the network device. The command display area 220 shows all commands in a hierarchical tree structure (as shown in FIG. 2B). The configuration display area 230 displays the getting page 300 or the setting page 400. The event message display area 240 displays running status information of the network management system 100.

FIG. 2B schematically illustrates a command tree displayed on the command display area 220 of the GUI 110, in accordance with the preferred embodiment of the present invention. The command tree comprises bridging commands, routing commands, service commands, security commands, and system commands. The bridging commands are used for configuring bridge connections of the network device. The routing commands are used for configuring routings of the network device. The service commands are provided for configuring the class, policy and quality of service on the network device. The security commands are provided for configuring the security environment that the network device works in. The system commands are used for configuring operation information on the network management system 100. Each of the commands comprises a plurality of sub-commands to implement different functions. For example, the bridging commands are used for displaying Group Multicast Registration Protocol (GMRP) configuration information, port configuration information, Virtual Local Area Network (VLAN) configuration information, and so on. An administrator can choose the sub-commands to obtain corresponding configuration information by clicking on corresponding sub-command buttons using a computer mouse.

FIG. 3A schematically illustrates a getting page 300 displayed on the configuration display area 230 of the GUI 110, in accordance with the preferred embodiment of the present invention. The administrator requests the getting page 300 by selecting any one of the commands of the command tree of FIG. 2B. For example, the getting page 300 displays VLAN configuration information on the network device when the VLAN command is selected. The getting page 300 comprises a table name 301 (such as a VLAN Entry List), additional information 302 for specifying descriptions of some abbreviations (such as V-Member and Untagged Set, M-Member and Tagged Set, or F-Forbidden Set), and an entry table 303 for displaying the detailed configuration information on the network device.

The entry table 303 is illustrated in detail in FIG. 3B. Through the entry table 303, the administrator can obtain a starting VLAN ID, a current port status, and a current status of the VLAN. In addition, the entry table 303 also provides a modify button and a delete button. The delete button is used for canceling the current VLAN configuration information. The modify button is used for sending the URL-encoded instruction to the GUI 110 to obtain the setting page 400.

FIG. 4A schematically illustrates a setting page 400 displayed on the configuration display area 230 of the GUI 110, in accordance with the preferred embodiment of the present invention. The setting page 400 comprises a table name 401 (such as a VLAN entry configuration), additional information 402 for specifying descriptions of some abbreviations (such as V-Member and Untagged Set, M-Member and Tagged Set, or F-Forbidden Set), and a parameter table 403 for displaying the current configuration information that is in modified mode. Furthermore, the setting page 400 comprises a submit button 404 and a reset button 405. The submit button 404 is used for sending newly configured parameters to the GUI 110 to update the current configuration information on the network device. The reset button 405 is used for clearing all the configuration parameters in the parameter table 403.

The parameter table 403 is illustrated in detail in FIG. 4B. By employing the parameter table 403, the administrator can modify the configuration parameters defined in the function library 131 item by item. In the embodiment described herein, the administrator inputs the VLAN configuration information that comprises a name, a starting VLAN ID, a current port set, and a current status of the VLAN. In addition, if the administrator needs to modify the current port status, the member set, the forbidden set, and the untagged set of the current ports can be reset.

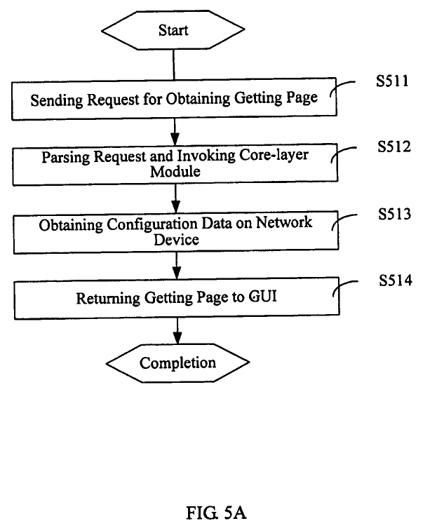

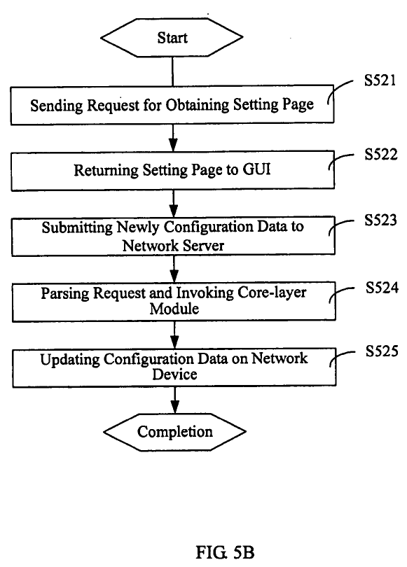

FIG. 5A is a flow chart of a preferred network management method when the GUI 110 receives a request for obtaining configuration information, in accordance with the present invention. At step S511, the GUI 110 sends the URL-encoded instruction to the network server 120 for obtaining a getting page 300. At step S512, the network server 120 parses the URL-encoded instruction and invokes the core-layer module 130. Firstly, the network engine 121 converts the URL-encoded instruction to a getting object to drive the HTML routine module 122. Then, the HTML routine module 122 retrieves the getting template and generates a getting application based on the getting object. The getting application invokes the getting function of the get/set module 123 to drive the configuration-executing sub-module 132 in the core-layer module 130. At step S513, the configuration-executing sub-module 132 invokes corresponding functions stored in the function library 131 to obtain configuration data on the network device. At step S514, the network server 120 sends the getting page 300 to the GUI 110. In detail, firstly, the get/set module 123 receives the configuration data sent by the configuration-executing sub-module 132, and returns the configuration data to the HTML routine module 122. The HTML routine module 122 fills the getting template with the configuration data to generate a getting HTML routine. Then, the HTML routine module 122 transmits the getting HTML routine to the network engine 121. The network engine 121 converts the getting HTML routine to the getting page 300, and sends the getting page 300 to the GUI 110.

FIG. 5B is a flow chart of a preferred network management method when the GUI 110 receives a request for resetting configuration information on the network device, in accordance with the present invention. At step S521, the GUI 110 sends the URL-encoded instruction for obtaining the setting page 400 to the network server 120. At step S522, the network server 120 returns the setting page 400 to the GUI 110. In detail, firstly, the network engine 121 converts the URL-encoded instruction to a search object to drive the HTML routine module 122. The HTML routine module 122 retrieves the setting template based on the search object. Then, the network engine 121 converts the setting template to the setting page 400, and returns the setting page 400 to the GUI 110. At step S523, the GUI 110 submits the newly configuration data for updating configuration information on the network device to the network server 120 when the submit button 404 in the setting page 400 is clicked on. At step S524, the network server 120 parses the request and invokes the core-layer module 130. The network engine 121 converts the URL-encoded instruction to the setting object to drive the HTML routine module 122. Then, the HTML routine module 122 generates a set application based on the setting object. The set application invokes the setting function of the get/set module 123 to invoke the configuration-executing sub-module 132 in the core-layer module 130. At step S525, the configuration-executing sub-module 132 invokes corresponding functions stored in the function library 131 to update the configuration information on the network device based on the set application.

Although only a preferred embodiment and method of the present invention have been described in detail above, those skilled in the art will readily appreciate that a plurality of modifications to the preferred embodiment and method are possible without materially departing from the novel teachings and advantages of the present invention. Accordingly, all such modifications are deemed to be covered by the following claims and allowable equivalents of the claims.

1. A system for configuring and managing a network device, comprising:
a graphical user interface (GUI) for receiving configuring and managing demands;
a network server connected to the GUI for receiving the demands from the GUI, the network server comprising:
a network engine for converting the demands to objects; and
a routine module for generating applications based on the objects and for retrieving routine templates;
a core-layer module for obtaining configuration data on the network device according to the applications, and for returning the configuration data to the network server.

2. The system as recited in claim 1, wherein the network server further comprises a get/set module for returning the configuration data to the routine module from the core-layer module.

3. The system as recited in claim 1, wherein the routine module fills routine templates with configuration data to generate routines.

4. The system as recited in claim 1, wherein the network engine converts the routines to human-readable network pages and returns the human-readable network pages to the GUI to display the configuration data on the network device.

5. The system as recited in claim 1, wherein the configuring and managing demands comprise demands for obtaining the configuration data on the network device, and demands for resetting the configuration data on the network device.

6. The system as recited in claim 1, wherein the core-layer module comprises a function library for storing various functions.

7. The system as recited in claim 1, wherein the core-layer module further comprises a configuration-executing sub-module for invoking functions stored in the function library according to the applications to obtain the configuration data on the network device, and for updating the configuration data on the network device.

8. A method for configuring and managing a network device, comprising the steps of:
(a) receiving a demand and converting the demand to an object;
(b) retrieving a getting routine template and generating an application based on the object;
(c) obtaining configuration data on the network device based on the application and filling the getting routine template with configuration data to generate a getting routine;
(d) converting the getting routine to a human-readable network getting page, for displaying of the network getting pages on a graphical user interface (GUI);
(e) receiving demands for obtaining setting pages for resetting configuration data on the network device and converting the demands to objects to retrieve setting routine templates;
(f) generating applications based on the objects and converting the setting routine templates to human-modified getting pages;
(g) obtaining an instruction for resetting the configuration data on the network device, and converting the instruction to objects; and
(h) generating applications based on the instruction to reset the configuration data on the network device.

9. The method as recited in claim 8, wherein the network getting page contains configuration data on the network device.

10. A method for configuring and managing a network device, comprising the steps of:
providing a graphical user interface (GUI) in a connection with said network device;
organizing display of said GUI to independently and respectively display configuration data of said network device and command information for managing said network device;
selecting one command from said command information via said GUI;
parsing said one command; and
managing said network device based on said one command.

11. The method as recited in claim 10, wherein said command information is displayed as a command tree in said GUI.

12. The method as recited in claim 10, wherein said one command is to get said configuration data from said network device in said managing step, which comprises the steps of:
retrieving a getting routine template;
retrieving said configuration data from said network device to fill said getting routine template with said configuration data; and
converting said getting routine template with said configuration data to a user-readable getting page in order for displaying in said GUI.

13. The method as recited in claim 10, wherein said one command is to update said configuration data of said network device in said managing step, which comprises the steps of:
retrieving a user-readable setting pages for resetting said configuration data via GUI;
converting said reset configuration data in a setting routine template; and
updating said configuration data of said network device to said reset configuration data based on said setting routine template.
